(19) United States
(12) Patent Application Publication
(10) Pub. No.: US 2006/0181216 A1
(43) Pub. Date: Aug. 17, 2006

(54) Lamp assembly

(76) Inventors: Joseph Franciscus Raymond Eijsermans, Eindhoven (NL); Walterus Johannes Maria Dekkers, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/552,051

(22) PCT Filed: Apr. 2, 2004
(86) PCT No.: PCT/IB04/50383

§ 371 Date: Oct. 4, 2005

(30) Foreign Application Priority Data
Apr. 10, 2003 (EP) 03100963.2

(51) Int. Cl. H01J 5/32

(52) U.S. Cl. 313/626

(57) ABSTRACT

A lamp assembly has a vacuumtight lamp vessel (22) of quartz glass. The lamp vessel has a longitudinal axis (8) and has at least one vessel end portion (1). At least one metal-foil electrical feed-through (3A, 4A, 5A; 3B, 4B, 5B) provides an electrical connection from the interior of the lamp vessel through the vessel end portion to outside the lamp vessel. According to the invention, at least a portion (3A, 3B) of the metal-foil electrical feed-through is arranged in the vessel end portion in a plane substantially perpendicular to the longitudinal axis. Preferably, the metal-foil electrical feed-through comprises a central foil portion (3A; 3B) and a first and a second foil end portion (4A, 5A; 4B, 5B), the central foil portion (3A; 3B) being arranged in the plane perpendicular to the longitudinal axis. The first and second foil end portions issue from the vessel end portion. The lamp assembly has a short axial seal length.

The invention relates to a lamp assembly that utilizes a lamp vessel of quartz glass with at least one metal-foil electrical feed-through.

Quartz glass is commonly used as a lamp vessel material in metal halide lamps and (tungsten) halogen incandescent lamps. The lamp vessel of quartz glass defines a sealed lamp interior containing a filament or discharge electrodes and a suitable chemical filling. Electrical energy is supplied to the filament or to the electrodes by means of electrical feed-throughs which pass through the lamp vessel at the location of a vessel end portion and which are hermetically sealed to the quartz glass. It is critical for lamp operation that the seal should remain intact throughout the life of the lamp.

Current conductors comprising metal foils are widely used in seals when the glass of the seal has a coefficient of thermal expansion which is lower than the corresponding coefficient of the metal. This is the case if the glass must have a high softening temperature in view of the operational conditions, while the metal for the same reason and because of the high manufacturing temperature of the seal must have a high melting point, such as tungsten and molybdenum.

The use of a metal foil means that the difference in coefficient of expansion between the glass, for example quartz glass, does not detract from the vacuumtightness of the seal. A condition for this is, however, that the axial edges of the metal foil are relatively thin and relatively sharp, i.e. the metal foil has axial knife edges (also called feathered edges).

A very suitable metal foil for use as an electrical feed-through is molybdenum. Since molybdenum foil is very thin, its absolute thermal expansion is extremely small. As a consequence, in combination with the knife edges of the metal foil, the probability of seal failure due to differential thermal expansion is relatively small. In a conventional design, the quartz glass is press-sealed to the molybdenum foil, a molybdenum electrical conductor is welded to the external end of the metal foil, and a suitable electrical conductor is welded to the internal end of the metal foil.

A lamp assembly of the kind mentioned in the opening paragraph is known from U.S. Pat. No. 5,021,711. The known lamp assembly comprises a lamp vessel including a vessel end portion in the form of a press seal. The lamp assembly comprises at least one molybdenum-foil electrical feed-through in the press seal connecting the lamp interior to an external electrical conductor. In the known lamp assembly, the molybdenum foil has an oxidation-inhibiting material embedded in a surface layer thereof by ion implantation.

A disadvantage of the known lamp assembly is that the lamp assembly is comparatively voluminous.

The invention has for its object to eliminate the above disadvantage wholly or partly. According to the invention, a lamp assembly of the kind mentioned in the opening paragraph for this purpose comprises:

a lamp vessel of quartz glass closed in a gastight manner, the lamp vessel having a longitudinal axis and comprising at least one vessel end portion,

at least one metal-foil electrical feed-through providing electrical connection from the interior of the lamp vessel through the vessel end portion to outside the lamp vessel,

at least a portion of the metal-foil electrical feed-through being arranged in the vessel end portion in a plane substantially perpendicular to the longitudinal axis.

An advantage of the lamp assembly according to the invention is that, by arranging the portion of the metal-foil electrical feed-through in the vessel end portion in a plane substantially perpendicular to the longitudinal axis, the length of the lamp assembly is considerably reduced. The lamp assembly has a relatively short axial seal length of the vessel end portion as compared with the known lamp assembly. In practice, a lamp assembly with an axial seal length of the vessel end portion of approximately 2 mm can be made.

Since the metal-foil electrical feed-through is arranged in a plane substantially perpendicular to the longitudinal axis in the lamp assembly according to the invention, the current conductors which are to be attached to the metal-foil electrical feed-through have to be bent in order to achieve a proper connecting of the current conductors. This bending of the current conductors can be avoided in that a metal-foil electrical feed-through comprising three portions is provided. To this end a preferred embodiment of the lamp assembly according to the invention is characterized in that the metal-foil electrical feed-through comprises a central foil portion and a first and a second foil end portion, the central foil portion being arranged in the plane perpendicular to the longitudinal axis and the first and second foil end portions issuing from the vessel end portion, such that the first foil end portion extends to the interior of the lamp vessel and the second foil end portion extends to outside the lamp vessel.

The lamp assembly may comprise a so-called double-ended lamp in which two vessel end portion are provided at mutually opposed sides of the lamp vessel. In an alternative embodiment, the lamp assembly comprises a so-called single-ended lamp in which the lamp vessel is provided with only one vessel end portion. To this end a preferred embodiment of the lamp assembly according to the invention is characterized in that the vessel end portion is provided with a first and a second metal-foil electrical feed-through.

There are various ways in which the first and second metal-foil electrical feed-through can be arranged in the vessel end portion. In a preferred embodiment of the lamp assembly according to the invention, the first metal-foil electrical feed-through comprises a first central foil portion and the second metal-foil electrical feed-through comprises a second central foil portion, the first central foil portion being arranged substantially parallel to the second central foil portion. In an alternative, preferred embodiment of the lamp assembly according to the invention, the first metal-foil electrical feed-through comprises a first central foil portion and the second metal-foil electrical feed-through comprises a second central foil portion, the first central foil portion being arranged in a crossing relationship with respect to the second central foil portion.

Preferably, the metal-foil electrical feed-through comprises molybdenum. The molybdenum foil and the molybdenum electrical conductor have a tendency to oxidize to form MoO₂ and MoO₃. The molybdenum oxides form in the region where the external conductor and the molybdenum foil are connected and cause a significant amount of stress on the seal. Eventually, the quartz seal will crack, thereby causing lamp failure. To reduce oxidation, a preferred embodiment of the lamp assembly according to the invention is characterized in that the surface of the metal-foil electrical feed-through is preferably (partially) provided with an oxidation-inhibiting material.

Preferably, the metal-foil electrical feed-through comprises a pair of mutually opposed knife edges extending transversely to the longitudinal axis.

The lamp assembly according to the invention may include an incandescent filament located in the interior of the lamp vessel and connected to the metal-foil electrical feed-through.

The lamp assembly according to the invention may include a discharge electrode located in the interior of the lamp vessel and coupled to the metal-foil electrical feed-through.

The invention will now be elucidated in more detail with reference to a number of embodiments and a drawing, in which:

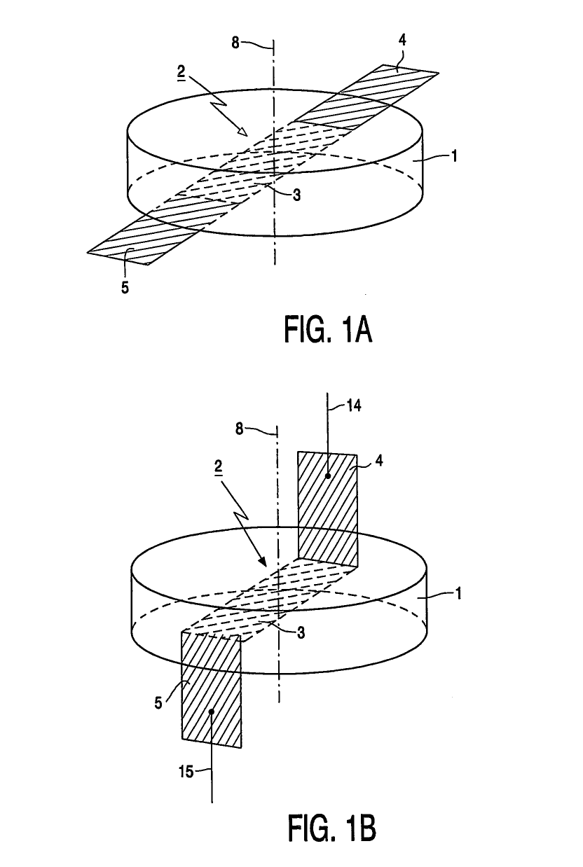

FIGS. 1A and 1B show steps of a method of making a metal-foil electrical feed-through according to an embodiment of the invention;

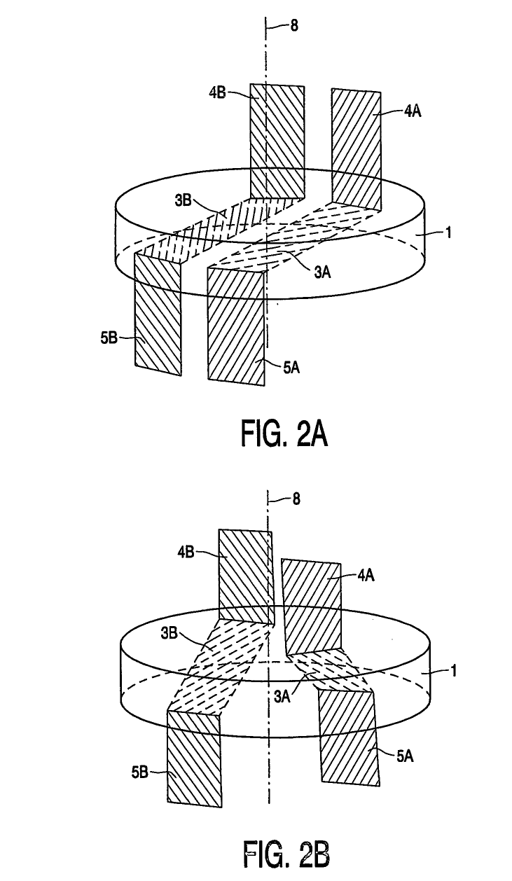

FIGS. 2A and 2B show two metal-foil electrical feed-throughs provided in a vessel end portion according to alternative embodiments of the invention;

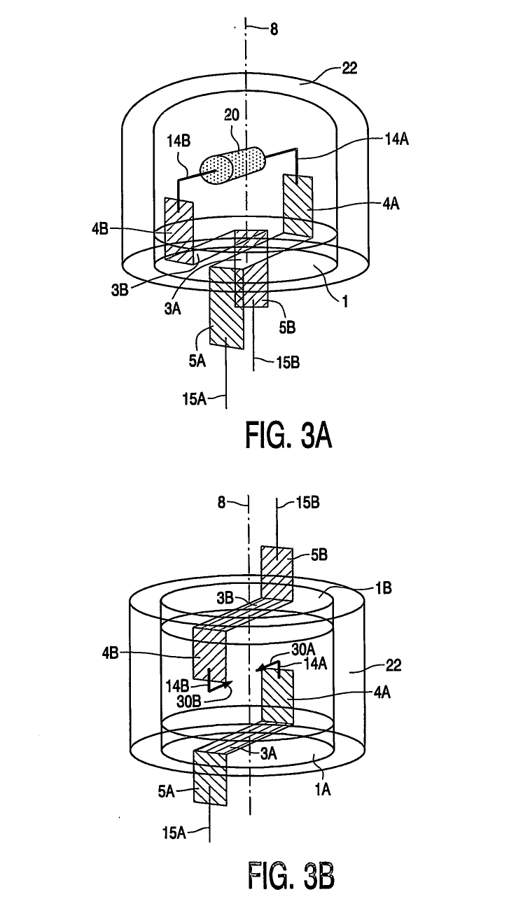

FIG. 3A shows an example of a lamp assembly comprising a single-ended lamp vessel, and

FIG. 3B shows an example of a lamp assembly comprising a double-ended lamp vessel.

The Figures are purely diagrammatic and not drawn true to scale. Some dimensions are particularly strongly exaggerated for reasons of clarity. Equivalent components have been given the same reference numerals as much as possible in the Figures.

FIGS. 1A and 1B very schematically show steps of a method of making a metal-foil electrical feed-through according to an embodiment of the invention. In a vessel end portion 1 in the form of a flat quartz glass disc, a metal foil 2, preferably made of molybdenum, is sealed parallel to the plane of the quartz glass disc. FIG. 1A shows a longitudinal axis 8 perpendicular to the plane of the quartz glass disc. A central foil portion 3 of the metal foil 2 is embedded in the quartz glass disc. A first and a second foil end portion 4, 5 emerge at the plane of circumference of the quartz glass disc. The foil end portions 4, 5 protruding from the quartz glass disc are bent upwards and downwards, respectively (FIG. 1B). As a next step, electrical conductors 14, 15 are connected to the foil end portions 4, 5 (FIG. 1B). According to the invention, the central foil portion 3 of the metal-foil electrical feed-through 2 is arranged in the vessel end portion 1 in a plane substantially perpendicular to the longitudinal axis 8.

FIGS. 2A and 2B very schematically show two metal-foil electrical feed-throughs provided in a vessel end portion according to alternative embodiments of the invention. A first and a second central foil portion 3A; 3B are embedded in the vessel end portion 1 in the form of a quartz glass disc. A first and a second foil end portion 4A, 4B; 5A, 5B emerge at both (flat) sides of the quartz glass disc with a longitudinal axis 8. The foil end portions 4A, 4B; 5A, 5B protruding from the quartz glass disc have been bent upwards and downwards, respectively. In the embodiment of FIG. 2A, the first central foil portion 3A is arranged substantially parallel to the second central foil portion 3B. In an alternative embodiment (FIG. 2B) the first central foil portion is arranged in a crossing relationship with respect to the second central foil portion. According to the invention, the central foil portion 3 of the metal-foil electrical feed-through 2 is arranged in the vessel end portion 1 in a plane substantially perpendicular to the longitudinal axis 8.

It will be clear that the central foil portions 3A, 3B of the first and the second metal-foil electrical feed-through 3A, 4A, 5A; 3B, 4B, 5B have to be provided in the vessel end portion 1 such that electrical contact between the first and the second metal-foil electrical feed-through 3A, 4A, 5A; 3B, 4B, 5B is avoided. In addition, the arrangement of the vessel end portion 1 as shown in the Figures is not limited to a particular shape. The vessel end portion may have any suitable shape, e.g. a square, round or oval shape, depending on the application of the vessel end portion 1.

FIG. 3A very schematically shows an example of a lamp assembly comprising a so-called single-ended lamp vessel. A single-ended lamp vessel only comprises one vessel end portion 1. The vessel end portion 1 of the lamp assembly is provided with a first metal-foil electrical feed-through 3A, 4A, 5A and a second metal-foil electrical feed-through 3B, 4B, 5B. The first metal-foil electrical feed-through 3A, 4A, 5A has a first central foil portion 3A and the second metal-foil electrical feed-through 3B, 4B, 5B has a second central foil portion 3B. According to the invention, the first central foil portion 3A and the second central foil portion 3B are arranged in the vessel end portion 1 in a plane substantially perpendicular to the longitudinal axis 8. In the example of FIG. 3A, the first central foil portion 3A is arranged substantially parallel to the second central foil portion 3B.

The lamp assembly as shown in FIG. 3A includes a (tungsten) incandescent filament 20 located in the interior of the lamp vessel 22 and coupled to the metal-foil electrical feed-through 4A; 4B. In addition, the first foil end portion 4A; 4B is provided with an inner conductor 14A; 14B in the interior of the lamp vessel 22. The second foil end portion 5A; 5B is provided with an outer conductor 15A; 15B outside the lamp vessel 22. The inner conductors 14A; 14B are connected to the incandescent filament 20.

FIG. 3B very schematically shows an example of a lamp assembly comprising a so-called double-ended lamp vessel. In double-ended lamp, two vessel end portions 1A, 1B are provided at mutually opposed sides of the lamp vessel. The first vessel end portion 1A of the lamp assembly is provided with a first metal-foil electrical feed-through 3A, 4A, 5A. The first metal-foil electrical feed-through 3A, 4A, 5A has a first central foil portion 3A. The second vessel end portion 1B of the lamp assembly is provided with a second metal-foil electrical feed-through 3B, 4B, 5B. The second metal-foil electrical feed-through 3B, 4B, 5B has a second central foil portion 3B. According to the invention, the first central foil portion 3A in the first vessel end portion 1A and the second central foil portion 3B in the second vessel end portion 1 are arranged in planes substantially perpendicular to the longitudinal axis 8. In addition, the first central foil portion 3A in the first vessel end portion 1A and the second central foil portion 3B in the second vessel end portion 1B are arranged substantially parallel to each other.

The lamp assembly as shown in FIG. 3B includes two spaced-apart discharge electrodes 30A, 30B located in the interior of the lamp vessel 22 and coupled to the metal-foil electrical feed-throughs 4A; 4B. In addition, the first foil end portions 4A; 4B are provided with a first inner conductor 14A connected to the discharge electrode with reference numeral 30A and a second inner conductor 14B connected to the discharge electrode with reference numeral 30B, respectively. In addition, each second foil end portion 5A; 5B is provided with an outer conductor 15A; 15B outside the lamp vessel 22.

Preferably, the metal-foil electrical feed-through 2; 3, 4, 5; 3A, 4A, 5A; 3B, 4B, 5B is made of molybdenum. To reduce the tendency of undesired oxidization of the molybdenum foil, a surface layer of the metal-foil electrical feed-through 2; 3, 4, 5; 3A, 4A, 5A; 3B, 4B, 5B is preferably provided with an oxidation-inhibiting material. Preferably, the metal-foil electrical feed-through 2; 3, 4, 5; 3A, 4A, 5A; 3B, 4B, 5B comprises a pair of mutually opposed knife edges (not shown in the Figures) extending transversely to the longitudinal axis 8.

The lamp assembly according to the invention has a very short axial seal length of the vessel end portion and a relatively small diameter of the lamp vessel. In practice, a lamp assembly with an axial seal length of the vessel end portion of approximately 2 mm and a diameter of the lamp vessel of approximately 7 mm can be made. A lamp assembly according to the invention would be a miniature lamp with a dimension of approximately 7 mm in all directions.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. In the device claim enumerating several means, several of these means may be embodied by one and the same item of hardware. The mere fact that certain measures are recited in mutually different dependent claims does not indicate that a combination of these measures cannot be used to advantage.

1. A lamp assembly comprising:
a lamp vessel (22) of quartz glass closed in a gastight manner, the lamp vessel (22) having a longitudinal axis (8) and comprising at least one vessel end portion (1; 1A, 1B),
at least one metal-foil electrical feed-through (2; 3, 4, 5; 3A, 4A, 5A; 3B, 4B, 5B) providing an electrical connection from the interior of the lamp vessel (22) through the vessel end portion (1) to outside the lamp vessel (22),
at least a portion (3; 3A, 3B) of the metal-foil electrical feed-through (2; 3, 4, 5; 3A, 4A, 5A; 3B, 4B, 5B) being arranged in the vessel end portion (1) in a plane substantially perpendicular to the longitudinal axis (8).

2. A lamp assembly as claimed in claim 1, characterized in that the metal-foil electrical feed-through (2; 3, 4, 5; 3A, 4A, 5A; 3B, 4B, 5B) comprises a central foil portion (3; 3A; 3B) and a first and a second foil end portion (4, 5; 4A, 5A; 4B, 5B), the central foil portion (3A; 3B) being arranged in the plane perpendicular to the longitudinal axis (8) and the first and second foil end portions (4, 5; 4A, 5A; 4B, 5B) issuing from the vessel end portion (1), such that the first foil end portion (4; 4A; 4B) extends to the interior of the lamp vessel (22) and the second foil end portion (5; 5A; 5B) extends to outside the lamp vessel (22).

3. A lamp assembly as claimed in claim 1, characterized in that the vessel end portion (1) is provided with a first and a second metal-foil electrical feed-through (3A, 4A, 5A; 3B, 4B, 5B).

4. A lamp assembly as claimed in claim 2, characterized in that the first metal-foil electrical feed-through (3A, 4A, 5A) comprises a first central foil portion (3A) and the second metal-foil electrical feed-through (3B, 4B, 5B) comprises a second central foil portion (3B), the first central foil portion (3A) being arranged substantially parallel to the second central foil portion (3B).

5. A lamp assembly as claimed in claim 2, characterized in that the first metal-foil electrical feed-through (3A, 4A, 5A) comprises a first central foil portion (3A) and the second metal-foil electrical feed-through (3B, 4B, 5B) comprises a second central foil portion (3B), the first central foil portion (3A) being arranged in a crossing relationship with respect to the second central foil portion (3B).

6. A lamp assembly as claimed in claim 2, characterized in that the first foil end portion (4A; 4B) is provided with an inner conductor (14A; 14B) in the interior of the lamp vessel (22) and that the second foil end portion (5A; 5B) is provided with an outer conductor (15A; 15B) outside the lamp vessel (22).

7. A lamp assembly as claimed in claim 1, characterized in that the metal-foil electrical feed-through (2; 3, 4, 5; 3A, 4A, 5A; 3B, 4B, 5B) comprises molybdenum.

8. A lamp assembly as claimed in claim 1, characterized in that a surface of the metal-foil electrical feed-through (2; 3, 4, 5; 3A, 4A, 5A; 3B, 4B, 5B) is provided with an oxidation-inhibiting material.

9. A lamp assembly as claimed in claim 1, characterized in that the metal-foil electrical feed-through (2; 3, 4, 5; 3A, 4A, 5A; 3B, 4B, 5B) comprises a pair of mutually opposed knife edges extending transversely to the longitudinal axis (8).

10. A lamp assembly as claimed in claim 1, further including an incandescent filament (20) located in the interior of the lamp vessel (22) and connected to the metal-foil electrical feed-through (4A; 4B).

11. A lamp assembly as claimed in claim 1, further including a discharge electrode (30A, 30B) located in the interior of the lamp vessel (22) and coupled to the metal-foil electrical feed-through (4A; 4B).
